(19) United States
(12) Patent Application Publication
(10) Pub. No.: US 2026/0028058 A1
(43) Pub. Date: Jan. 29, 2026

(54) PORTABLE BEACH VEHICLE WITH RETRACTABLE Wheels

(71) Applicant: Trenton Driver, Dozier, AL (US)

(72) Inventor: Trenton Driver, Dozier, AL (US)

(21) Appl. No.: 19/276,281

(22) Filed: Jul. 22, 2025

Related U.S. Application Data
(60) Provisional application No. 63/675,366, filed on Jul. 25, 2024.

(51) Int. Cl. B62B 13/18; B62B 3/00; B62B 3/02; B62B 5/06; B62B 17/06

(52) U.S. Cl. CPC B62B 13/18; B62B 3/003; B62B 3/02; B62B 5/06; B62B 17/061; B62B 2206/006; B62B 2301/044; B62B 2501/06

(57) ABSTRACT

A portable beach vehicle having retractable wheels that allow the vehicle to convert between a wagon for use on hard surfaces and a sled for use on soft surfaces, such as sand, is provided. The vehicle has a container for holding items to be transported by the vehicle. The container is mounted on a sled that can be used to manually pull the vehicle over soft surfaces. Each of the wheels can be deployed to convert the vehicle from a sled to a wheeled wagon that can be manually pulled on hard surfaces. When used as a sled, each of the wheels can be retracted to a position in which each wheel is entirely above the sled so that the wheels do not interfere with motion of the vehicle as a sled.

### FIELD OF THE INVENTION

The present disclosure relates generally to a portable beach vehicle having retractable wheels that allow the vehicle to convert between a wagon for use on hard surfaces and a sled for use on soft surfaces, such as sand.

### BACKGROUND

Beachgoers who frequently spend significant amounts of time on beaches often bring numerous items with them to enhance their enjoyment of the beach. Such items may include beach chairs, beach towels, beach umbrellas, coolers with drinks and/or food, sunscreen, hats or other articles of clothing, and any other items they may wish to use on the beach, such as a radio, a book, or a beachball. Beachgoers need to transport these items from their automobile or residence, which can sometimes be a fairly long distance from the beach. To transport these items in a single trip, beachgoers frequently use a wagon or cart. Some carts are specifically designed for beach use and have wide wheels to help the wheels of the cart roll over a sandy surface more effectively. However, even with wide wheels it is sometimes very difficult to pull a cart through sand that is loaded with items using rolling wheels, thereby causing the user to exert significant energy. In some cases, beachgoers will use a sled-type vehicle that can simply be dragged over the surface of the sand to transport these items. However, when the user is transporting items over a hard surface such as pavement during a portion their journey to the beach, a sled cannot be used. There have been some attempts to combine features of a wheeled cart with features of a sled, but such devices typically don't function as well as a conventional wheeled cart when used on hard surfaces or as well as a conventional sled when used on sandy surfaces.

### SUMMARY

In one aspect, a portable beach vehicle having retractable wheels that allow the vehicle to convert between a wagon for use on hard surfaces and a sled for use on sandy or other types of soft or uneven surfaces is provided. The vehicle comprises a sled and a container mounted on the sled. The container may be used for holding items to be transported over both hard and soft surfaces using the vehicle. The vehicle has wheels that roll on a transport surface when the vehicle is used as a wagon and that are retractable when the vehicle is used as a sled. Each of the wheels is configured to move to a deployed position to convert the vehicle to the wagon configuration, and each wheel is also configured to move to a retracted position to convert the vehicle to the sled configuration. When the vehicle is in the wagon configuration, the wheels are all disposed below the bottom side of the sled so that the wheels can roll over a hard transport surface with the sled being elevated above the hard surface so that the sled does not contact the surface. When the vehicle is in the sled configuration, the wheels are all disposed entirely above the bottom side of the sled so that the bottom of the sled contacts and slides along the surface over which the vehicle is being used to transport items without the wheels ever contacting the soft transport surface.

In a preferred embodiment, the vehicle includes a frame attached to the top of the sled, and the frame supports a pliable canvas container suitable for holding items to be transported. The vehicle preferably also includes a handle attached to the front of the sled for pulling the vehicle in either the wagon configuration or the sled configuration. In a preferred embodiment, the wheels are each attached to a mounting structure that is rotatably mounted onto the frame so that each wheel can be individually deployed by rotating the combination of wheel and wheel mounting structure to the deployed position and then individually retracted by rotating the wheel and wheel mounting structure to the retracted position. The vehicle includes a locking mechanism for locking each wheel in either the deployed position or retracted position so that the wheels do not move from the desired position during use of the vehicle. Because each of the wheels can be completely retracted to a position in which each wheel is entirely above the bottom of the sled, the wheels do not interfere with the functioning of the sled when sliding the vehicle over sand or any other surface that is relatively soft compared to a hard surface such as pavement.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### DESCRIPTION OF THE DRAWINGS

These and other features, aspects, and advantages of the present invention will become better understood with regard to the following description, appended claims, and accompanying drawings where:

FIG. 1 shows a perspective view of a vehicle capable of converting between a wagon and a sled deployed as a wagon in accordance with the present disclosure.

FIG. 2 shows a perspective view of a vehicle capable of converting between a wagon and a sled deployed as a sled in accordance with the present disclosure.

FIG. 3 shows a side elevational view of a vehicle capable of converting between a wagon and a sled in accordance with the present disclosure.

FIG. 4 shows a close-up perspective view of a portion of a vehicle capable of converting between a wagon and a sled in accordance with the present disclosure.

FIG. 5 shows a bottom perspective view of a sled portion of a vehicle capable of converting between a wagon and a sled in accordance with the present disclosure.

FIG. 6 shows a perspective view of a vehicle capable of converting between a wagon and a sled with a container portion removed in accordance with the present disclosure.

FIG. 7 shows an exploded view of components of a vehicle capable of converting between a wagon and a sled in accordance with the present disclosure.

FIG. 8 shows a perspective view of a component of a vehicle capable of converting between a wagon and a sled in accordance with the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

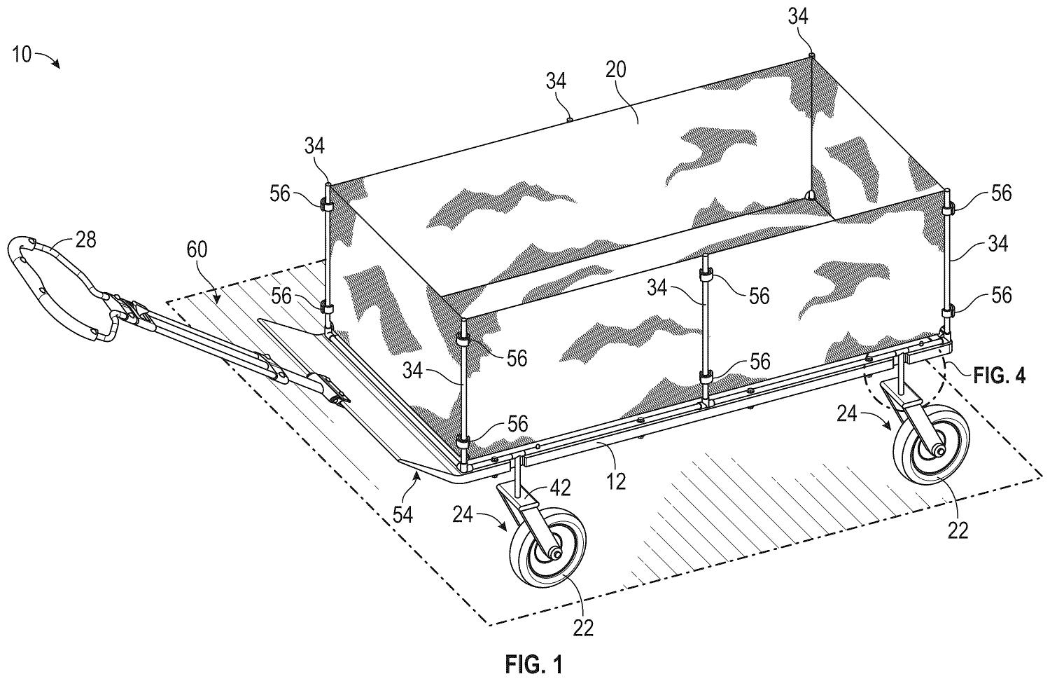

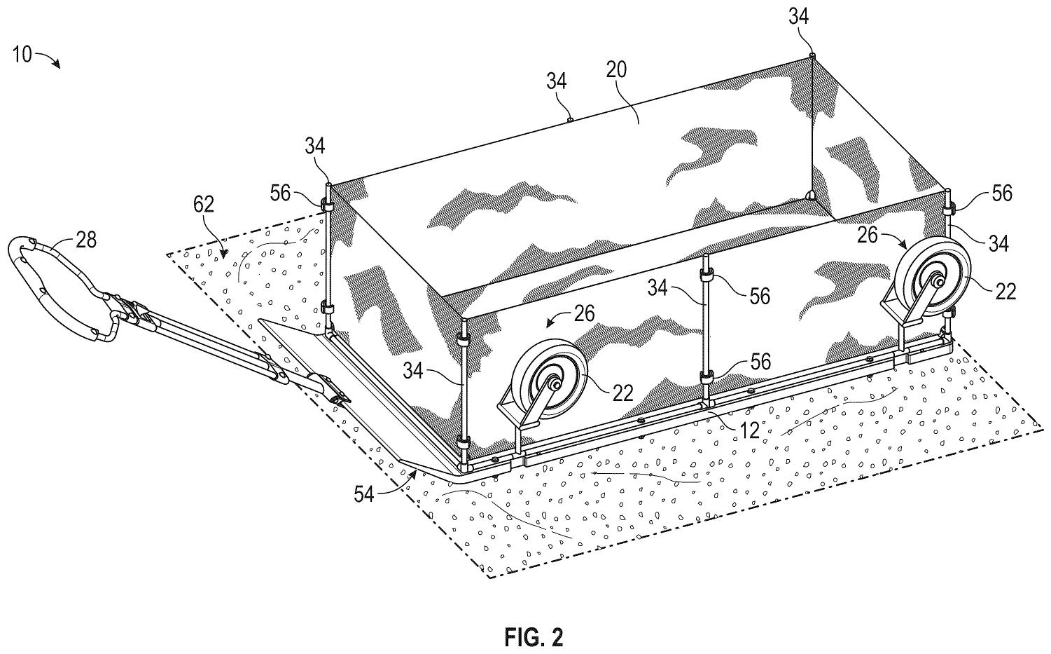

In one aspect, a vehicle 10 having retractable wheels 22 that allow the vehicle 10 to convert between a wagon configuration for use on hard surfaces 60 and a sled configuration for use on sandy or other types of soft or uneven surfaces 62 is provided. FIGS. 1-8 illustrate a preferred embodiment of the vehicle 10 or components thereof. The vehicle 10 comprises a plurality of wheels 22 for use when the vehicle 10 is in the wagon configuration, as best seen in FIG. 1. The wheels 22 are rotatably mounted on the vehicle 10 so that the wheels 22 can roll freely along a transport surface, which is preferably a hard surface 60, such as pavement. The vehicle 10 further comprises a sled 12 for use in when the vehicle 10 is in the sled configuration, as best seen in FIG. 2.

The sled 12 has a top side 14 and a bottom side 16. The top side 14 of the sled 12 is utilized for supporting and transporting items using the vehicle 10. The bottom side 16 of the sled 12 contacts the soft transport surface 62 and slides along the surface to move the vehicle 10 and transport items thereon. The bottom side 16 of the sled 12 is preferably constructed of a material having a generally smooth, low-friction surface to facilitate ease of sliding the sled 12 over sand or similar types of soft surfaces 62. The bottom surface 16 may be polished or waxed to further reduce friction when sliding on a surface. The sled 12 also has two opposing lateral sides or lateral edges 18 that are each generally parallel to a direction of movement of the vehicle 10 when the vehicle 10 is being moved in either the wagon configuration or the sled configuration. In one embodiment, the bottom surface 16 may be a generally flat, planar surface extending between both lateral edges 18. Alternatively, the bottom surface 16 may have a plurality of ridges disposed parallel to a direction of travel of the vehicle 10 to facilitate the sled 12 sliding over and partially through portions of the sand forming the transport surface 62.

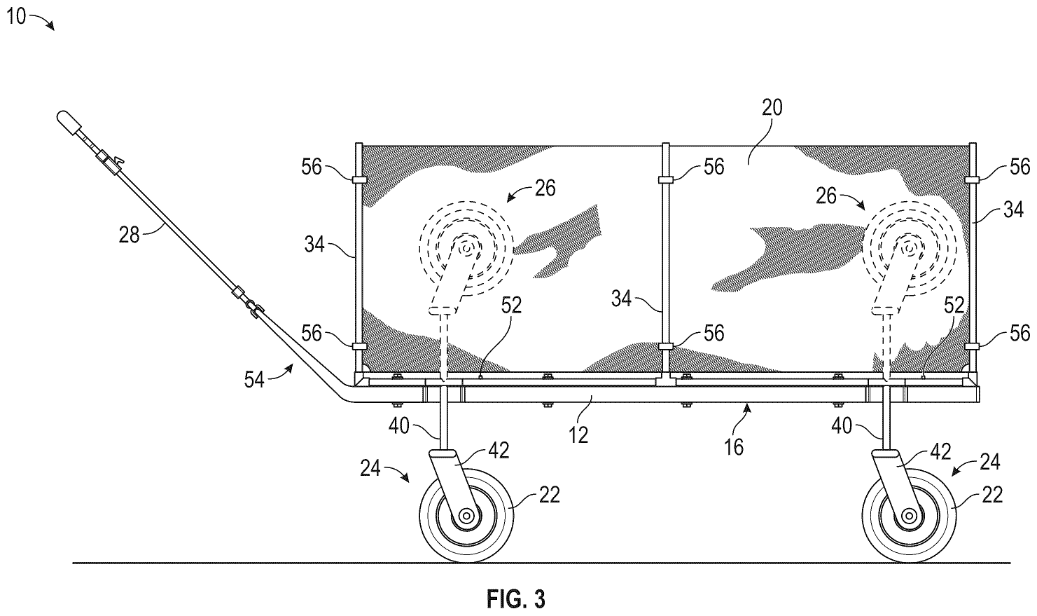

The sled 12 also has a front 54 that defines a leading portion of the sled 12 when the vehicle 10 is moving in a forward direction. As best seen in FIG. 3, the front 54 preferably has a section that is angled or curved upwardly relative to the rest of the sled 12 so that the sled 12 can easily move in a forward direction with the front 54 moving over the sand without the front 54 getting caught in sand. The sled 12 preferably has a handle 28 attached to the front end 54 of the sled 12, as shown in FIGS. 1-3. The handle 28 is configured to allow a user to pull the vehicle 10 when the vehicle 10 is in either the sled configuration or the wagon configuration. Thus, the user may pull the handle 28 to roll the wagon wheels 22 over a hard surface 60 or to slide the sled 12 over a soft surface 62.

The vehicle 10 further comprises a container 20 mounted on the top side 14 of the sled 12. The container 20 may be used for holding items to be transported over both hard and soft surfaces using the vehicle 10. In a preferred embodiment, the container 20 is constructed of a rugged canvas material or other similar type of pliable material. A canvas container 20 helps to minimize the overall weight of the vehicle 10 and is suitable for transporting the types of items that a user would typically take on a beach trip.

In a preferred embodiment, the vehicle 10 comprises four wheels 22, though a different number of wheels 22 may be contemplated. Each of the wheels 22 is configured to move to a deployed position 24 to convert the vehicle 10 to the wagon configuration, as best seen in FIG. 1, and each wheel 22 is also configured to move to a retracted position 26 to convert the vehicle 10 to the sled configuration, as best seen in FIG. 2. FIG. 3 illustrates the relative positioning of the wheels 22 in both the deployed position 24 and the retracted position 26. When the vehicle 10 is in the wagon configuration, at least a portion of each of the wheels 22 is disposed below the bottom side 16 of the sled 10, as best seen in FIG. 3, so that the wheels 22 can roll over a hard transport surface 60 with the sled 12 being elevated above the hard surface 60 so that the sled 12 does not contact the surface 60. In a preferred embodiment, each wheel 22 is disposed entirely below the bottom side 16 of the sled 12 when the vehicle 10 is in an upright position for normal use, as best seen in FIG. 3. When the vehicle 10 is in the sled configuration with the wheels 22 in the retracted position 26, the wheels 22 are all disposed entirely above the bottom side 16 of the sled 12 so that the bottom 16 of the sled 12 contacts and slides along the surface 62 over which the vehicle 10 is being used to transport items without allowing the wheels 22 to ever contact the surface 62.

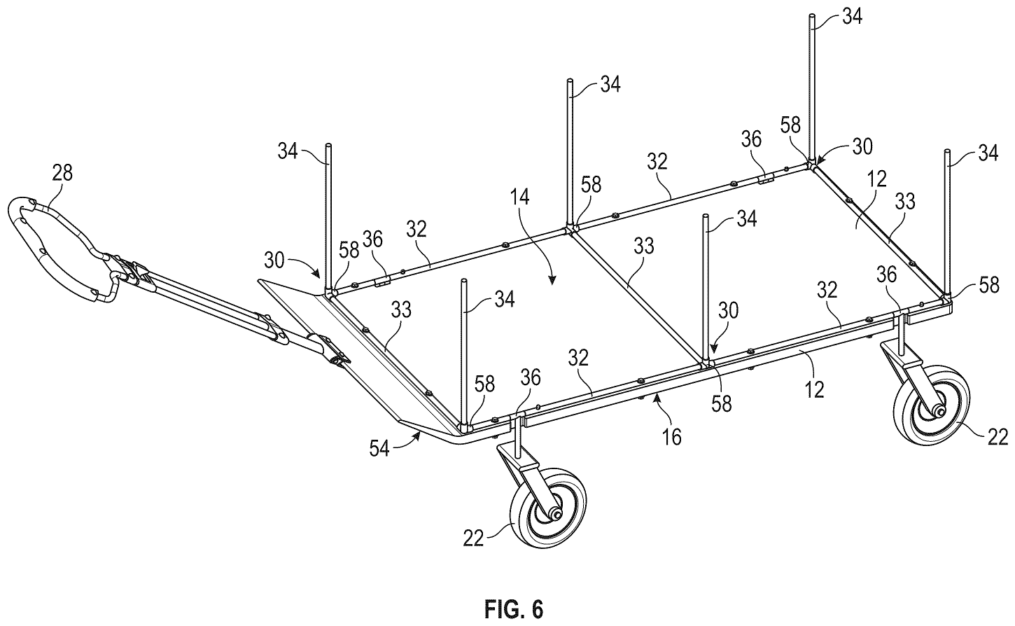

In a preferred embodiment, the vehicle 10 includes a frame 30 attached to the top side 14 of the sled 12, as best seen in FIG. 6, which shows the vehicle with the canvas container 20 removed. The frame 30 may be used to support the canvas container 20. In a preferred embodiment, the frame 30 comprises a plurality of support posts 34 each extending upwardly from the top side 14 of the sled 12. The frame 30 preferably has at least four support posts 34, which are generally positioned at four corners of the sled 12. The frame 30 may optionally include additional support posts 34 as shown in FIG. 6, which shows the frame 30 with six support posts 34. As shown in FIG. 1, the canvas container 20 may be attached to each of the support posts 34. In one embodiment, the canvas container 20 includes a plurality of sleeves 56 generally positioned at locations corresponding to the plurality of support posts 34. In this embodiment, the canvas container 20 may be installed on the frame 30 simply by inserting each of the support posts 34 into each of the sleeves 56 and sliding each of the support posts 34 through the sleeves 56. Each sleeve 56 may optionally be formed by straps that can be removably attached to each other and detached from each other, such as straps having hook and loop fasteners, so that the straps can be wrapped around a support post 34 to secure the canvas container 20 to the post 34. Alternatively, the canvas container 20 may be secured to the support posts 34 using other suitable types of fastening devices.

In a preferred embodiment, as best seen in FIG. 6, the frame 30 comprises a pair of hollow elongated frame tubes 32 each attached to the top side 14 of the sled 12 and disposed generally along the lateral edge 18 of the sled 12. The frame 30 may optionally also include two or more cross tubes 33 each having opposing ends attached to each respective one of the frame tubes 32. At least two cross tubes 33 may be positioned generally near the front end 54 of the sled 12 and an opposing rear end of the sled 12, respectively, and be disposed perpendicularly to each of the frame tubes 32. The cross tubes 33 may provide additional structural support for the frame tubes 32 and support posts 34. Each of the frame 30 members 32, 33, 34 are preferably made of rigid material such as a metal material or rigid plastic material and preferably have a circular cross-sectional area. The frame tubes 32 may be attached to the sled 12 by bolts and nuts or any other suitable types of fasteners. In a preferred embodiment, each of the wheels 22 are attached to the frame 30, and preferably to the frame tubes 32 extending along the lateral edges 18 of the sled 12. The frame tubes 32, cross tubes 33, and support posts 34 may be connected to each other at one of a plurality of joints generally disposed at four corners of the sled 12. Each joint may be formed by a three-way or four-way elbow fitting 58.

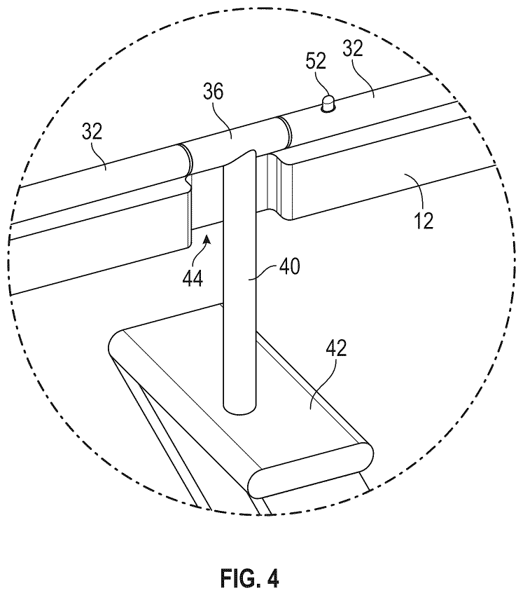

In a preferred embodiment, each of the wheels 22 is attached to a support rod 40 that is rotatably mounted onto the frame 30, as best seen in FIG. 4. In one embodiment, the support rod 40 is attached to a wheel bracket 42 that is preferably attached to each wheel 22 on opposing sides of the wheel 22 so that the wheel 22 is rotatably attached to the bracket 42. A lower end of the support rod 40 may be directly attached to an upper end of the wheel bracket 42, and an upper end of the support rod 40 is preferably attached to one of the frame tubes 32. Each of the wheels 22 is configured to be deployed and retracted by rotating the support rod 40 downwardly or upwardly, respectively, as best seen in FIG. 3.

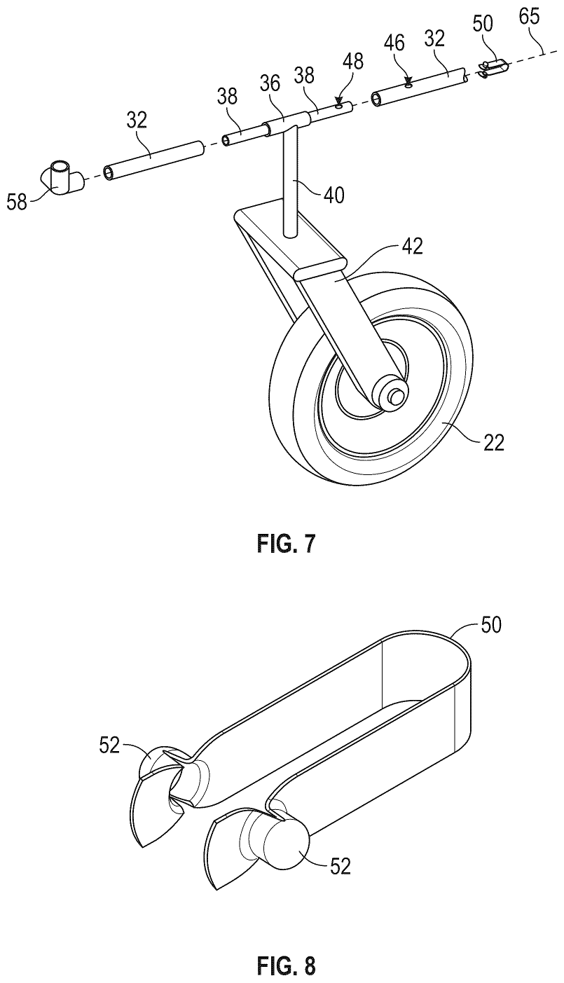

In a preferred embodiment, to rotatably mount the support rod 40 to the frame 30, the support rod 40 may be attached to a mounting bracket 36 having a portion 38 that is disposed within an interior of the hollow frame tube 32, as best seen in FIGS. 4 and 7. In this embodiment, each frame tube 32 may not be a continuous tube and may be segmented with a pair of mounting brackets 36 for each respective wheel 22 on one side 18 of the sled 12 segmenting each of the frame tubes 32. Thus, each segment of each frame tube 32 may be connected to an adjacent segment by a mounting bracket 36 but not directly attached to each other. Each segment of each frame tube 32 may be individually fastened to the top side 14 of the sled 12. Each mounting bracket 36 is configured to rotate when the portion 38 of the bracket 36 disposed in one of the segments of the frame tube 32 rotates within the hollow interior of the frame tube 32.

In a preferred embodiment, the vehicle 10 further comprises a locking mechanism 50 configured to lock each of the wheels 22 in the deployed position 24 and to configured to lock each of the wheels 22 in the retracted position 26. In the embodiment utilizing the rotating mounting brackets 36 for each wheel 22, the locking mechanism 50 is configured to prevent rotation of the mounting bracket 36 when the locking mechanism 50 is engaged. Thus, the locking mechanism 50 ensures that the wheels 22 remain in the deployed position 24 when the vehicle 10 is used as a wagon and remain in the retracted position 26 when used as a sled so that the wheels 22 are not inadvertently released and fall down when pulling the sled 12, thereby dragging in the sandy surface 62 and restricting movement of the vehicle 10.

In a preferred embodiment, as shown in FIG. 7, the portion of each mounting bracket 36 disposed within the hollow interior of the frame tube 32 may comprise a mounting tube 38 also having a hollow interior. The mounting tube 38 preferably has a circular cross-sectional area and has a slightly smaller outer diameter than an interior diameter of the frame tube 32 so that the mounting tube 38 fits within the frame tube 32 with only a very limited amount of annular space between the mounting tube 38 and frame tube 32. Each mounting bracket 36 may have a pair of mounting tubes 38 extending in opposite directions from opposing sides of the portion of the mounting bracket to which the support rod 40 is attached so that that mounting bracket 36 is supported by adjacent segments of the frame tube 32 and can rotate about an axis 65 defined by the longitudinal length of the frame tube 32.

In this embodiment utilizing rotating mounting brackets 36, each mounting tube 38 preferably has a pair of opposing openings 48 extending through walls of the mounting tube 38, and the frame tube 32 preferably also has a pair of opposing openings 46 extending through walls of the frame tube 32, as shown in FIG. 7. The pair of opposing openings 46 in the frame tube 32 are configured to align with the pair of openings 48 in the mounting tube 38 when the wheels 22 are in the deployed position 24 and also when the wheels 22 are in the retracted position 26. In this embodiment, the locking mechanism preferably comprises a spring clip 50, as shown in FIG. 8. The spring clip 50 is configured to fix the both the rotational position as well as the axial position of the mounting tube 38 and the frame tube 32 relative to each other. The spring clip 50 has two opposing protrusions 52 that are sized to fit within both the pair of openings 46 in the frame tube 32 and also within the pair of openings 48 in the mounting tube 38, thereby preventing rotation of the mounting tube 38 within the frame tube 32 when the protrusions 52 are disposed within openings 46 and 48. The clip 50 may be placed within the interior of the mounting tube 38. The clip 50 may have a C-shaped portion designed to bias the protrusions 52 in an outward direction relative to the longitudinal axis 65 of both tubes 32 and 38. The protrusions 52 can be pressed inwardly to allow the mounting tube 38 with the clip 50 disposed therein to rotate within the interior of the frame tube 32 between the deployed position 24 and the retracted position 26. When the mounting tube 38 is in the deployed position 24 or retracted position 26, openings 46 and 48 are aligned so that the protrusions 52 move outward due to the outward biasing force and into both pairs of openings 46 and 48 to retain tubes 32 and 38 in a fixed position relative to each other. The mounting tube 38 preferably has a smaller outer diameter than an outer diameter of the portion of the mounting bracket 36 to which the support rod 40 is attached. This configuration allows each mounting tube 38 to be fully inserted into each frame tube 32 to the proper axial position to align openings 46 with openings 48. At the proper axial position, an end of one segment of the frame tube 32 is contacting or in close proximity to the portion of the mounting bracket 36 to which the support rod 40 is attached.

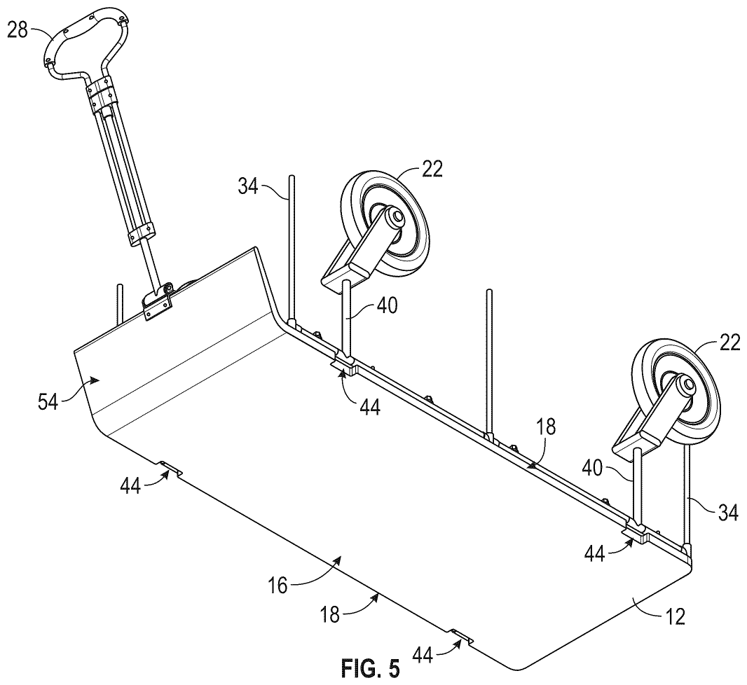

In a preferred embodiment, as best seen in FIG. 5, the sled 12 has a cutout portion 44 disposed adjacent to each respective one of the mounting brackets 36. Each cutout portion 44 has an open end along one of the lateral edges 18 of the sled 12. The support rod 40 to which one of the wheels 22 is attached is then positioned within a respective one of the cutout portions 44 when the wheel 22 is in the deployed position 24. Conversely, the support rod 40 is not positioned within the cutout portion 44 when the wheel 22 is in the retracted position 26, as shown in FIG. 5, because in this position 26 the support rod 40 is rotated upwardly so that the support rod 40 extends upwardly from the top side 14 of the sled 12. The cutout portions 44 allow each support rod 40 to be connected to one of the frame tubes 32 while also allowing each support rod 40 to be rotated to the deployed position 24 with the support rod 40 extending downwardly from the frame tube 32 and also downwardly from the bottom side 16 of the sled 12. This mounting configuration allows each wheel 22 to be individually deployed by rotating the combination of wheel 22 and wheel mounting structure 36, 40, 42 to the deployed position 24 and then individually retracted by rotating the wheel 22 and wheel mounting structure 36, 40, 42 to the retracted position 26. Because each of the wheels 22 can be completely retracted to a position 26 in which each wheel 22 is entirely above the bottom side 16 of the sled 12, the wheels 22 do not interfere with the functioning of the sled 12 when sliding the vehicle 10 over sand 62 or any other surface that is relatively soft compared to a hard surface 60 such as pavement. When the wheels 22 are moved to the retracted position 26, the wheels 22 may contact the exterior of the container 20. Because the container 20 is preferably constructed of canvas or a similar pliable material, the wheels 22 may cause the canvas material to move or be displaced without obstructing the placement of the wheels 22.

Although preferred embodiments of the present vehicle 10 include wheels 22 that are mounted onto a frame 30 using rotating mounting brackets 36 that can be locked in place utilizing spring clips 50, it should be understood by one of skill in the art that other wheel mounting and locking configurations may be contemplated. Thus, it should be understood by one of skill in the art that any wheel mounting configuration suitable for moving wheels 22 between a deployed position 24 for use as a wagon and a retracted position 26 in which each of the wheels 22 is disposed entirely above the bottom 16 of the sled 12 may be utilized and still fall within the scope of the present disclosure. It should be further understood by one of skill in the art that any wheel locking configuration suitable for locking each wheel 22 in both the deployed configuration 24 and in the retracted configuration 26 may be utilized and still fall within the scope of the present disclosure.

It will be appreciated that the configurations and methods shown and described herein are illustrative only, and that these specific examples are not to be considered in a limiting sense, because numerous variations are possible. The subject matter of the present disclosure includes all novel and non-obvious combinations and sub-combinations of the various systems and configurations, and other features, functions, and/or properties disclosed herein. It is understood that versions of the invention may come in different forms and embodiments. Additionally, it is understood that one of skill in the art would appreciate these various forms and embodiments as falling within the scope of the invention as disclosed herein.

What is claimed is:

1.) A vehicle for transporting items, wherein the vehicle is configured to convert between a sled configuration and a wagon configuration, wherein the vehicle comprises:
a sled having a top side and a bottom side;
a container mounted on the top side of the sled; and
a plurality of wheels configured to move to a deployed position to convert the vehicle to the wagon configuration and configured to move to a retracted position to convert the vehicle to the sled configuration,
wherein each of the wheels is disposed below the bottom side of the sled when deployed in the wagon configuration, and wherein each of the wheels is disposed entirely above the bottom side of the sled when retracted in the sled configuration.

2.) The vehicle of claim 1, further comprising a frame attached to the top side of the sled, wherein the frame comprises a plurality of support posts each extending upwardly from the top side of the sled, wherein the container comprises a fabric container attached to each of the support posts.

3.) The vehicle of claim 2, wherein each of the wheels is attached to a support rod that is rotatably mounted onto the frame, wherein each of the wheels is configured to be deployed and retracted by rotating the support rod downwardly or upwardly, respectively.

4.) The vehicle of claim 2, further comprising a locking mechanism configured to lock each of the wheels in the deployed position and to configured to lock each of the wheels in the retracted position.

5.) The vehicle of claim 4, wherein the frame comprises a hollow elongated frame tube, wherein the support rod is attached to a mounting bracket having a portion that is disposed within an interior of the hollow frame tube, wherein the mounting bracket is configured to rotate when the portion rotates within the hollow frame tube, wherein the locking mechanism is configured to prevent rotation of the mounting bracket when engaged.

6.) The vehicle of claim 5, wherein the portion comprises a mounting tube having a hollow interior, wherein the portion has a pair of opposing openings extending through walls of the mounting tube, wherein the frame tube has a pair of opposing openings extending through walls of the frame tube, wherein the pair of opposing openings in the frame tube and the mounting tube align with each other when the wheels are in the deployed position and when the wheels are in the retracted position, wherein the locking mechanism comprises a spring clip having two opposing protrusions that are sized to fit within the openings in the walls of both the frame tube and the mounting tube, thereby preventing rotation of the mounting tube within the frame tube.

7.) The vehicle of claim 5, wherein the sled has a cutout portion disposed adjacent to each respective one of the mounting brackets, wherein each cutout portion has an open end along a lateral edge of the sled, wherein the support rod to which one of the wheels is attached is positioned within a respective one of the cutout portions when the wheel is in the deployed position, and wherein the support rod is not positioned within the cutout portion when the wheel is in the retracted position.

8.) The vehicle of claim 1, wherein the sled has a handle attached to a front end of the sled, wherein the handle is configured to allow a user to pull the vehicle when the vehicle is in either the sled configuration or the wagon configuration.

9.) A vehicle for transporting items, wherein the vehicle is configured to convert between a sled configuration and a wagon configuration, wherein the vehicle comprises:
a sled having a top side and a bottom side,
wherein the sled has a cutout portion disposed adjacent to each respective one of the mounting brackets,
wherein each cutout portion has an open end along a lateral edge of the sled,
wherein the sled has a handle attached to a front end of the sled,
wherein the handle is configured to allow a user to pull the vehicle when the vehicle is in either the sled configuration or the wagon configuration;
a container mounted on the top side of the sled;
a plurality of wheels configured to move to a deployed position to convert the vehicle to the wagon configuration and configured to move to a retracted position to convert the vehicle to the sled configuration,
wherein each of the wheels is disposed below the bottom side of the sled when deployed in the wagon configuration,
wherein each of the wheels is disposed entirely above the bottom side of the sled when retracted in the sled configuration,
wherein each of the wheels is attached to a support rod that is rotatably mounted onto the frame,
wherein each of the wheels is configured to be deployed and retracted by rotating the support rod downwardly or upwardly, respectively;
a frame attached to the top side of the sled,
wherein the frame comprises a plurality of support posts each extending upwardly from the top side of the sled,
wherein the container comprises a fabric container attached to each of the support posts,
wherein the frame comprises a hollow elongated frame tube,
wherein the support rod is attached to a mounting bracket having a portion that is disposed within an interior of the hollow frame tube,
wherein the mounting bracket is configured to rotate when the portion rotates within the hollow frame tube,
wherein the portion comprises a mounting tube having a hollow interior,
wherein the portion has a pair of opposing openings extending through walls of the mounting tube,
wherein the frame tube has a pair of opposing openings extending through walls of the frame tube,
wherein the pair of opposing openings in the frame tube and the mounting tube align with each other when the wheels are in the deployed position and when the wheels are in the retracted position,
wherein the support rod to which one of the wheels is attached is positioned within a respective one of the cutout portions when the wheel is in the deployed position,
wherein the support rod is not positioned within the cutout portion when the wheel is in the retracted position; and
a locking mechanism configured to lock each of the wheels in the deployed position and to configured to lock each of the wheels in the retracted position,
wherein the locking mechanism is configured to prevent rotation of the mounting bracket when engaged,
wherein the locking mechanism comprises a spring clip having two opposing protrusions that are sized to fit within the openings in the walls of both the frame tube and the mounting tube, thereby preventing rotation of the mounting tube within the frame tube.

10.) A method of using a vehicle on both a hard surface and on a soft surface, said method comprising the step of deploying each of a plurality of wheels when using the vehicle on a hard surface and retracting each of the plurality of wheels when using the vehicle on a soft surface.
